(19) United States
(12) Patent Application Publication
(10) Pub. No.: US 2013/0066809 A1
(43) Pub. Date: Mar. 14, 2013

(54) Method of Identifying Patterns in Stock Market Data

(71) Applicant: Scott Andrew Tattersall, Howth (IE)

(72) Inventor: Scott Andrew Tattersall, Howth (IE)

(21) Appl. No.: 13/698,696

(22) PCT Filed: May 30, 2011
(86) PCT No.: PCT/EP2011/058860

§ 371 Date: Nov. 19, 2012

(30) Foreign Application Priority Data
May 28, 2010 (IE) S2010/0349

(51) Int. Cl. G06Q 40/06

(52) U.S. Cl. 705/36 R

(57) ABSTRACT

The present invention relates to a method of identifying patterns in stock market data, the method comprising the steps of converting the stock market data for a given time period into a character representation of the stock market data; generating a string of character representations of the stock market data for a plurality of given time periods; and searching the string of character representations for a given sequence of character representations, the sequence representing a known pattern. The method provides for efficient identification of patterns in stock market date, in particular micro-patterns.

### CROSS REFERENCE TO RELATED APPLICATIONS

The present application claims priority to PCT Application No. PCT/EP2011/058860 filed 30 May 2011, which in turn claims priority to Irish Patent Application No. S2010/0349 filed 28 May 2010, said applications being incorporated in their entirety herein by reference thereto.

### FEDERALLY SPONSORED RESEARCH AND DEVELOPMENT

None.

### BACKGROUND OF THE INVENTION

1. Field of the Invention

This invention relates to a method of identifying patterns in stock market data.

2. Background

It is highly desirable to be able to identify and locate patterns in financial data such as stock market data. This is due to the fact that if coherent patterns can be identified in the stock market data then it is possible to recognise and predict the future occurrence of similar patterns and realise profitable trades.

Stock market data is often represented graphically as a stock chart and there are a number of existing algorithms that attempt to scan these stock charts in order to find known patterns, for example a “cup and handle” pattern. The stock charts can also be represented by candlestick charts, where for each given time period, for example a day of stock market data, the data is graphically represented as a candlestick bar. A candlestick bar shows the opening price, the high price, the low price, and the closing price and whether the stock is up or down in value for the time period in a single graphical representation. The candlestick bar comprises a body defined by the opening price and the closed price and shadows which mark the intra-time period range from body to high price and body to low price. There are also existing algorithms which attempt to find known candlestick patterns, for example the Morning Star Doji Pattern, in these candlestick charts.

There are however significant technical problems in the area of pattern matching algorithms for stock market data. More specifically, there are problems relating to the speed of data processing of traditional pattern finding algorithms and the computing power that is required. The size of the stock market, coupled with the granularity of the potential data set makes the known algorithms highly impractical for all but the most superficial of searches. For example, if one were to attempt to find patterns in the stock market data of all the Fortune 500 companies for the last ten years, the known algorithms would require the processing capability of a large supercomputer in order to perform the task in an acceptable period of time. It is simply not possible to perform the task on a standard personal computer in an acceptable time frame.

A further problem with the known methodologies is compounded by the very nature of the data and of the patterns that are sought. There are inexact visual matches that are sufficiently close semantic matches to the pattern being sought. The known search algorithms do not generally capture these close semantic matches.

It is an object of the present invention to provide a method of identifying patterns in stock market data that overcomes at least some of the problems with the known methods. Furthermore, it is an object of the present invention to provide a method of identifying patterns in stock market data that identifies the patterns in a fast and efficient manner.

### SUMMARY OF THE INVENTION

According to the invention there is provided a method of identifying patterns in stock market data, the method operating in a system comprising a processing module, the method comprising the steps of: (a) the processing module converting the stock market data for a given time period into a character representation of the stock market data; (b) the processing module generating a string of character representations of the stock market data for a plurality of given time periods; and (c) the processing module searching the string of character representations for a given sequence of character representations, the sequence representing a known pattern.

By having such a method it is possible to quickly search through the stock market data for patterns matching a desired pattern without the need for large amounts of computing power. By representing the stock market data as a character and then searching a string of characters representing the stock market data over a larger time period for a given sequence of character representations, it is possible to search for those sequences of character representations with the minimum of difficulty.

In one embodiment of the invention, there is provided a method in which the step of the processing module converting the stock market data for a given time period into a character representation of the stock market data comprises the steps of: (d) the processing module converting the stock market data into a candlestick bar; and thereafter (e) the processing module converting the candlestick bar into a character representation according to a set of conversion rules.

This is a particularly efficient way of converting the stock market data into a character representation. First of all, the stock market data is converted into a well-known graphical representation of the stock market data, the candlestick bar, and thereafter a set of rules is applied to the candlestick bar to designate a specific character to that candlestick bar representation.

In another embodiment of the invention, there is provided a method in which the step of the processing module searching the string of character representations for a given sequence of character representations comprises the processing module applying a DNA search string algorithm to the sequence of character representations and the string of character representations. DNA search string algorithms are highly suited for finding sequences of characters in large strings of characters and therefore this is seen as a very effective and innovative use of the DNA search string techniques to identify sequence patterns in financial market data. This is made possible by first of all converting the stock market data into a format that is searchable using these algorithms.

Preferably, the DNA search string algorithms are modified DNA search string algorithms adapted to retrieve close approximations of the optimum matching pattern, and return a ranked list of matches. In this way, the method ensures that both optimal matches and similar matches of the desired pattern are found.

In a further embodiment of the invention, there is provided a method in which the modified DNA search string algorithm is a hybrid DNA search string algorithm comprising elements of two or more DNA search string algorithms. In this way, the advantages of different DNA search string algorithms may be combined to form an improved algorithm.

In a further embodiment of the invention, there is provided a method in which the step of the processing module searching a string of character representations for a given sequence of character representations comprises applying a Needleman-Wunsch algorithm to the sequence of character representations and the string of character representations. Additionally or alternatively, the method may include the use of the Smith-Waterman Algorithm and/or Sellers Algorithm.

In a further embodiment of the invention, there is provided a method in which the character representation is an alphabetical character. This provides a particularly convenient set of representative characters.

In one embodiment of the invention, there is provided a method in which the stock market data for a particular time period is converted into one of thirteen characters.

In another embodiment of the invention, there is provided a method in which the step of the processing module searching the string of character representations for a given sequence of character representations comprises the initial step of: (f) defining a custom similarity matrix to define the varying degrees of similarity between the characteristics of stock market data as represented by candlesticks of specific time periods.

By doing so, it is possible to provide a scoring matrix for each of the matching patterns and this scoring matrix may thereafter be analysed to rank the matching sequences in an ordered list and thereafter provide that ordered list to the user. In this way, not only the exact matches may be reviewed, but also the inexact matches may be reviewed and indeed provided to the user in a meaningful manner.

In a further embodiment of the invention, there is provided a method in which the custom similarity matrix defines the varying degrees of similarity between candlestick bar shapes.

In one embodiment of the invention, there is provided a method comprising the further step of: (g) the processing module returning a ranked list of identified patterns.

In another embodiment of the invention, there is provided a method in which the user selects a desired sensitivity to the search thereby filtering out unsuitable matches. This is particularly advantageous for the user.

In a further embodiment of the invention, there is provided a method comprising the processing module generating a scoring matrix and adding each score value in the scoring matrix to an ordered key/value collection.

In one embodiment of the invention, there is provided a method in which the key is the ranking and the value is a list of locations within the scoring matrix where that ranking occurs.

In another embodiment of the invention, there is provided a method comprising the step of the processing module converting a combination of two or more character representations into a second character representation. In this way, a faster, less computationally intensive search may be carried out.

According to a further embodiment of the invention, there is provided a computer program having program instructions that when executed on a computer causes the computer to implement the method of the invention.

In a further embodiment, the method of the invention is combined with known existing investment strategies to form an amalgamated rule; and, real-time monitoring of stock market data is conducted to detect concurrence with the amalgamated rule.

### BRIEF DESCRIPTION OF THE DRAWINGS

The invention will be more clearly understood from the following description of some embodiments thereof, given by way of example only with reference to the accompanying drawings.

FIG. 1 is a diagram of market data illustrating a “cup and handle” pattern.

FIG. 2 is a diagrammatic representation of market data expressed using candlestick bars.

FIGS. 3(a) to 3(k) are diagrammatic representations of common types of candlestick bars.

FIG. 4 is a diagrammatic representation of a sequence alignment produced by ClustalW of a pair of two human zinc finger proteins.

FIG. 5 is a diagrammatic representation of the steps taken in the method according to the invention.

FIGS. 6(a) to 6(e) inclusive are screenshots illustrating the steps of the method according to the invention.

FIG. 7 is a diagrammatic representation of the custom similarity matrix for use in generating the scoring matrix.

FIG. 8 is a diagrammatic representation of a scoring matrix and the progression through a scoring matrix.

### DETAILED DESCRIPTION OF THE INVENTION

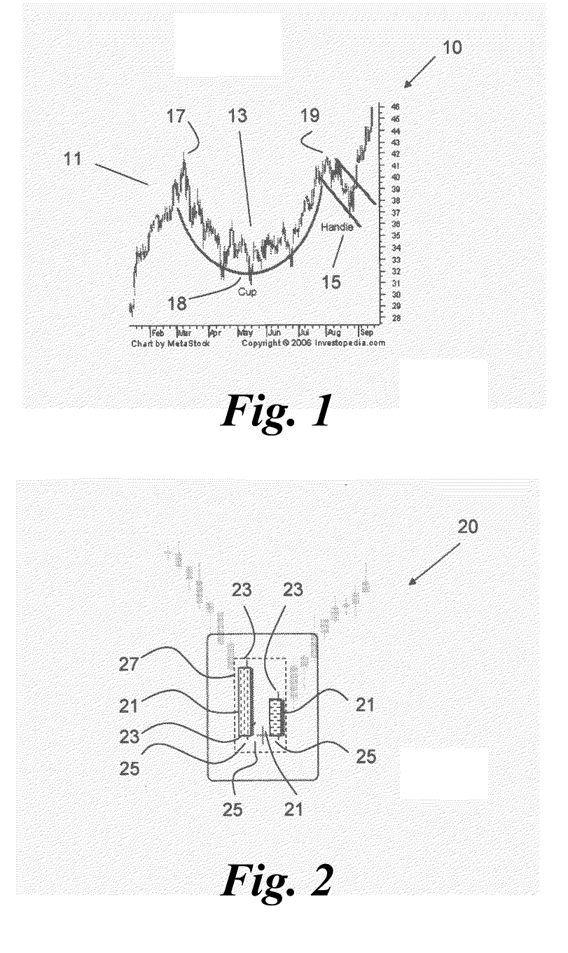

Referring to FIG. 1, there is shown a diagrammatic representation of market data, indicated by the reference numeral 10, showing a typical pattern 11 found in stock market data. The pattern 11 is commonly referred to as the “cup and handle” pattern and has a “cup” portion 13 and a “handle” portion 15.

In searching for cup and handle patterns, a number of well-defined conditions are required: the first condition requires an existing trend towards the peak 17. The second condition requires the depth of the cup 13, measured from the peak 17 to the trough 18, is not more than ⅔^{rds} the length of the prior trend to 17 (more typically the depth of the cup 13 from peak 17 to trough 18 is of the order of ⅓^{rd} the length of the prior trend to the peak 17). The third condition requires that the price peaks 17, 19 defining the cup are at a similar price. The fourth condition requires that the handle, starting from peak 19 does not retrace more than ⅔^{rds} of the depth of the cup. It is typical for the handle 15 to retrace of the order of ⅓^{rd} the depth of the cup 13. Unlike cup 13 depths, it is rare for true handles 15 to extend beyond ⅓^{rd} of the depth of the cup 13. The cup and handle pattern completes when prices break past peaks 17 and 19 and the predictive power of the cup and handle comes into play. The price projection minimum for the pattern to be true is the depth of the cup added (for a rising stock) or subtracted (for a falling stock) to the peak highs (for a rising stock) or from peak lows (for a falling stock) as marked by 17 and 19. Time is also a variable with cups forming over 1-6 months with handles lasting 1-4 weeks.

It will be understood that in practice, what traders will watch for upon discovering a suspected cup and handle pattern is the breakout of the stock price above the handle 15 at the same time as unusual trading volume. A higher volume of trades at the same time as the breakout reduces the chances of a “false breakout”. The finding of the cup and handle pattern is the first step in the process of predicting the markets movements. Therefore, by recognising a cup and handle pattern, it is possible to use this information along with other information to predict the projected minimum price of the stock at some point in the future.

Referring to FIG. 2 of the drawings there is shown a plurality of sequential candlestick bars, indicated generally by the reference numeral 20 that are used to represent the stock market data for a particular financial instrument including the real body 21 as defined by the opening price and the closing price, the upper shadow 23 comprising the distance from the real body 21 to the highest price and the lower shadow 25 comprising the distance from the real body 21 to the lowest price for a given time period. The colour (or shading) of the candlestick bar is governed by the relationship of the current closing price to the previous closing price, but also by the current opening price to the current closing price and the position of each relative to the prior days' close. Candlesticks can be applied to any financial instrument over any time period where open, high, low and closing prices are available.

The section 27 of the sequential series of candlestick bars, shown in dashed outline, illustrates a candlestick pattern that analysts frequently attempt to detect. This candlestick pattern is referred to as a “morning star Doji” pattern. The morning star Doji pattern is a three candlestick pattern that consists of a large-bodied down candlestick, shown with a vertical dashed hatching; followed by a “doji” candlestick (a candlestick where the real body is reduced to merely a line because the open and closing price are essentially the same), followed by a smaller bodied up candlestick, shown with a horizontal dashed hatching.

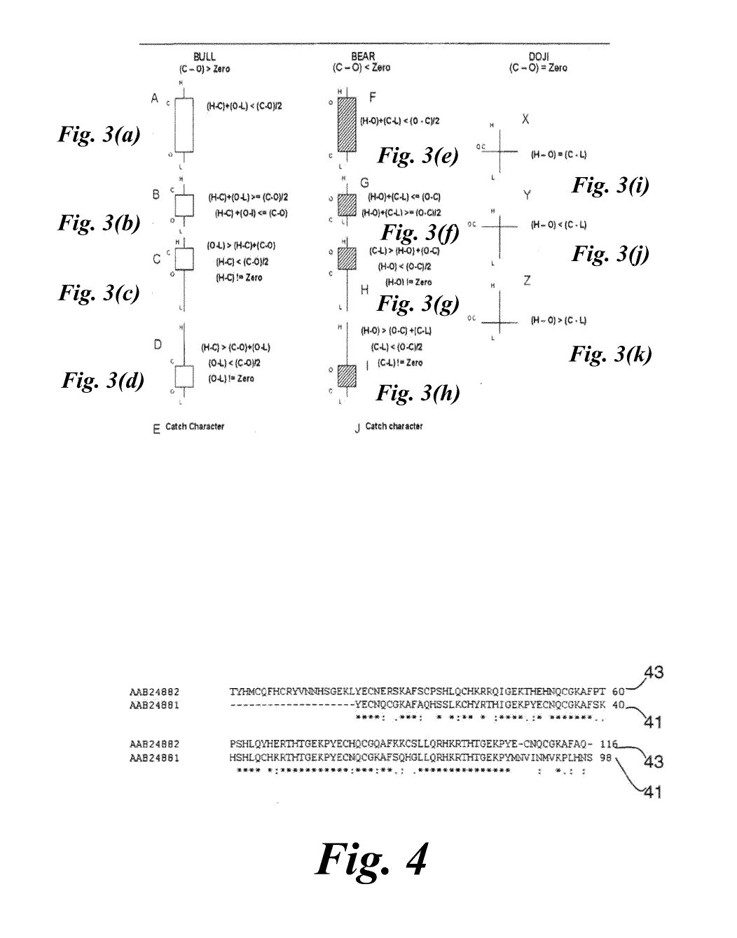

Referring now to FIGS. 3(a) to 3(k) inclusion, there are shown a number of common candlestick patterns in three broad categories, namely bull, bear and doji categories. In each of FIGS. 3(a) to 3(k) inclusive, the letter H represents the time period high, the letter L represents the time period low, the letter O represents the time period opening and the letter C represents the time period closing.

Referring specifically to FIGS. 3(a) to 3(d) inclusive, it can be seen that in a bull category, the closing price is always greater than the opening price and therefore a profit is made on that particular financial instrument over the time period. In FIG. 3(a), the opening price is close to the time period low and the closing price is close to the time period high and there is a significant spread between the opening price and the closing price. In FIG. 3(b), the opening price is also close to the time period low and the closing price is also close to the time period high, however the spread between the opening and the closing prices is significantly less. In FIG. 3(c), again the spread between the opening and closing prices is quite small, however, the financial instrument experienced a time period low significantly lower than the opening price and the time period high was close to the closing price. In FIG. 3(d), the spread between opening price and closing price is again quite small, however the opening price is close to the time period low whereas the financial instrument experienced a time period high which was significantly greater than the closing price. In order to be categorised as a bull, the closing price minus the opening price must be greater than zero.

In order to be categorised according to the bull candlestick bar displayed in FIG. 3(a), the following equation must be satisfied:

(H−C)+(O−L)<(C−O)/2

In order to be categorised as a candlestick bar shown in FIG. 3(b) both of the following equations must be satisfied:

(H−C)+(O−L)>=(C−O)/2;

(H—C)+(O—L)<=(C—O).

In order to be classified as a candlestick bar according to FIG. 3(c), all of the following equations must be satisfied:

(O−L)>(H−C)+(C−O);

(H−C)<(C−O)/2;

(H−C)!=Zero

In order to be classified according to a candlestick bar displayed in FIG. 3(d), all of the following equations must be satisfied:

(H−C)>(C−O)+(O−L);

(O−L)<(C−O)/2;

(O−L)!=Zero

Each of the candlestick bars represented in FIGS. 3(a) to 3(d) inclusive are appointed a character, in this case an alphabetical character. The candlestick bar shown in FIG. 3(a) is appointed letter “A”, the candlestick bar shown in FIG. 3(b) is appointed the letter “B”, the candlestick bar shown in FIG. 3(c) is appointed letter “C” and the candlestick bar shown in FIG. 3(d) is appointed letter “D”. A catch character “E” represents a bull category day where there is no other character definition that satisfies the above conditions.

Referring to FIGS. 3(e) to 3(h) inclusive, there is shown the candlestick bars for a bear category. In order to qualify as a bear category, the following equation must be satisfied:

(C−O)<Zero

The candlestick bar shown in FIG. 3(e) has an opening price close to the time period high and a closing price close to the time period low with a significant spread between the opening and the closing prices. In order to satisfy the requirements to be a candlestick bar of this nature, the following equation must be satisfied:

(H−O)+(C−L)<(O−C)/2

The candlestick bar shown in FIG. 3(e) is designated the letter “F”.

Referring specifically to FIG. 3(f), the candlestick bar shown is representative of a bear category where the opening price is close to the time period high and the closing price is close to the time period low, but there is a smaller spread between the opening price and the closing price. In order to be categorised as this type of candlestick, both of the following equations must be satisfied:

(H−O)+(C−L)<=(O−C);

(H−O)+(C−L)>=(O−C)/2

The candlestick bar of FIG. 3(f) is appointed the letter “G”.

Referring specifically to FIG. 3(g), there is shown a candlestick bar in which the time period opening is close to the time period high and the time period closing is significantly greater than the time period low and the spread between the opening and the closing prices are relatively narrow. In order to be characterised as a candlestick bar of this nature, all of the following equations must be satisfied:

(C−L)>(H−O)+(O−C);

(H−O)<(O−C)/2;

(H−O)!=Zero

The candlestick bar shown in FIG. 3(g) has been appointed the letter “H” as the character representation.

Referring specifically to FIG. 3(h), there is shown a bear category candlestick bar in which the time period low is close to the time period closing and the time period opening is significantly less than the time period high, while the spread between the time period opening and the time period closing is relatively narrow. In order to satisfy the criteria to be categorised as a candlestick bar of this nature, all of the following equations must be satisfied:

(H−O)>(O−C)+(C−L);

(C−L)<(O−C)/2;

(C−L)!=Zero

The candlestick bar shown in FIG. 3(h) is appointed the letter “I” as the character representation. A further catch character “J” represents those bear category days when there is no other character definition found that satisfies the criteria outlined above.

Referring to FIGS. 3(i) to 3(k) inclusive, there are shown various candlestick bars for Doji categories. In order to satisfy the criteria of being a Doji category, the time period closing price minus the time period opening price must equal zero. In other words, though the stock price may fluctuate during the day and there may be a wide range of high and low values, the closing price at the end of the day is the same as the opening price at the start of the day.

Referring specifically to FIG. 3(i), it can be seen that the difference between the time period high and the opening and closing price is substantially equal to the difference between the time period low and the opening and closing price. In order to satisfy the criteria for a Doji category candlestick bar as shown in FIG. 3(i), the following equation must be satisfied.

(H−O)=(C−L)

The candlestick bar shown in FIG. 3(i) is appointed letter “X”.

Referring specifically to FIG. 3(j), there is shown a Doji category candlestick bar in which the opening and closing price are closer to the time period high than they are to the time period low. In order to be categorised as this type of candlestick bar, the following equation must be satisfied:

(H−O)<(C−L)

This candlestick bar type shown in FIG. 3(j) has been appointed the letter “Y”.

Referring specifically to FIG. 3(k), there is shown a candlestick bar for a Doji category in which the opening and closing price are closer to the time period low than they are to the time period high. In order to qualify to be categorised as this type of candlestick bar the following equation must be satisfied:

(H−O)>(C−L)

The candlestick bar shown in FIG. 3(k) is appointed letter “Z”.

It can be seen from the above FIGS. 3(a) to 3(k) and the foregoing description that stock market data that consists of the open, high, low and close of the underlying financial instrument in a given time period, for example a day, may be obtained and this data may be converted into a character representation which is equivalent to a DNA base, using a proprietory set of rules as outlined in the foregoing description. There is essentially a thirteen letter alphabet that may be used to represent each of the Bull, Bear and Doji categories, as well as some catch characters that represent those days that there is no other character representation that satisfies the criteria. In this way, it is possible to build candlestick bars for each time period for a given financial instrument and thereafter substitute the appropriate letter for the candlestick bar and subsequently build a string of characters that represent a number of consecutive time periods.

For example, the dashed section 27 of the candlestick chart shown in FIG. 2, the so-called “morning star doji”, could be represented by the character representation string “FXA”. This is a small subset of the possible overall character string and it is envisaged that the character string may be several thousand, tens of thousands, hundreds of thousands or indeed many millions of characters long. For example, if the time period is set to a day and the search wishes to analyse the performance of the 500 companies of the Fortune 500 companies over the last 10 years, there will be 1.25 million characters in the character string (assuming that the markets are open 250 days a year, 250×10×500). If the time period is set to one minute and the other parameters remain the same, there will be 600 million characters in the character string (assuming that the markets are only open for 8 hours a day).

In the example above, the “morning star Doji” pattern is represented by the character string “FXA”. However it will be understood that certain other combinations would be very close to the string “FXA”, such as “FXB”. A number of other sequences may also constitute “approximate” matches, for example “FYA”, “FYB”, “GXA”, “GXB” and the like. These approximate matches may be graded according to how closely they approximate the desired pattern. One particularly advantageous aspect of the present invention is that it is possible to determine the similarity of the approximate matches to the desired pattern and capture these approximate matches of interest also. A further advantageous aspect of the invention is the ability to then rank the approximate matches according to their similarity to the desired target pattern.

It will be understood that often the character sequences that are being searched for could be anything from two characters in length to tens, hundreds or thousands of characters long themselves. Practically speaking, the DNA pattern matching method is used for relatively small patterns (of the order of 10 characters or so). However, it is envisaged that larger sequence patterns could be searched for. This may be achieved by converting a combination of two or more first character representations into a further second character representation that represents the combination of the two or more first character representations. In other words, a further alphabet with a plurality of second character representations could be used to describe a plurality of combinations of first character representations from the existing first character representation alphabet. This will enable the present invention to scan for larger patterns by first of all converting a combination of two, three or more candlestick charts, letters or the data that the candlestick charts and letters are representative of, into single characters of a second character representation alphabet thereby reducing the character string that must be searched. In this way, both the size of the data being searched and the pattern being searched are kept to a minimum which will improve the speed of the search. More detail about the ability to capture and grade similar patterns aspect of the invention will be provided below.

By using the above approach, it is possible to rephrase the original problem of finding a particular visual pattern inside a larger pattern by now trying to find a sequence of characters inside a longer string of characters. This enables the use of DNA search techniques to search the stock market data represented by a string of characters. Various modifications are made to the existing DNA search algorithms for use with stock market data. It is necessary to provide a highly efficient and adaptive algorithm that can search through the data quickly, that can also identify imperfect matches in the target data of the required pattern.

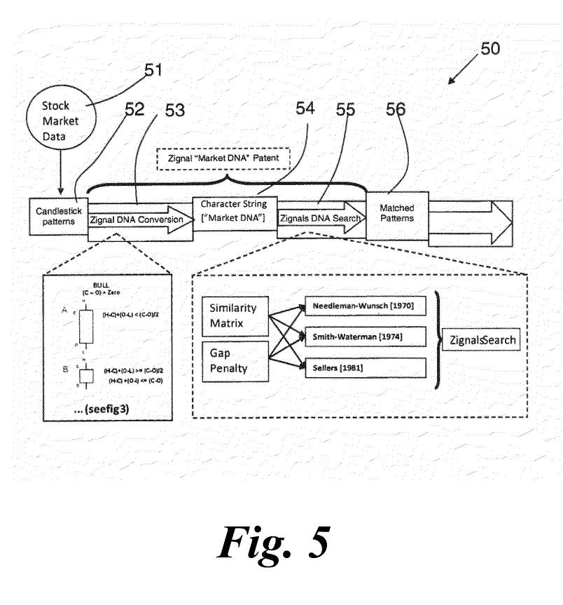

Referring to FIG. 4, there is shown a demonstration of sequence alignment for two human zinc finger proteins. A number of algorithms were developed in order to match up the sequence of characters 41 with the string of characters 43. These include the Needleman-Wunsch algorithm, the Sellers algorithm and the Smith-Waterman algorithm. All of these algorithms are examples of dynamic programming and are quite similar to each other. The main difference between the algorithms is how they align the strings. The three algorithms mentioned above require variables called the similarity matrix and a gap penalty to be initialised. According to the present invention there is provided a proprietory method which uses the above approaches of the algorithms as guidance and takes the best characteristics of each and combines them to form the desired output to the user. The precise operation of the search algorithm according to the invention will be more clearly described below.

Referring to FIG. 5 of the drawings, there is shown a diagrammatic representation of the operation of the method according to the invention indicated generally by the reference numeral 50. In step 51 stock market data is supplied to the processing module and in step 52 the processing module generates candlestick patterns from the stock market data. In step 53, the candlestick patterns are converted into their character representations by the processing module and in step 54, the string of characters representing the market data is generated by the processing module. In step 55, the user provides a known pattern to be found in the character string, the known pattern represented by a sequence of characters, and the character string is searched by the processing module for that sequence of characters. In step 56, matched patterns are returned and this may be followed up by profit assessment and results and profit estimation if desired.

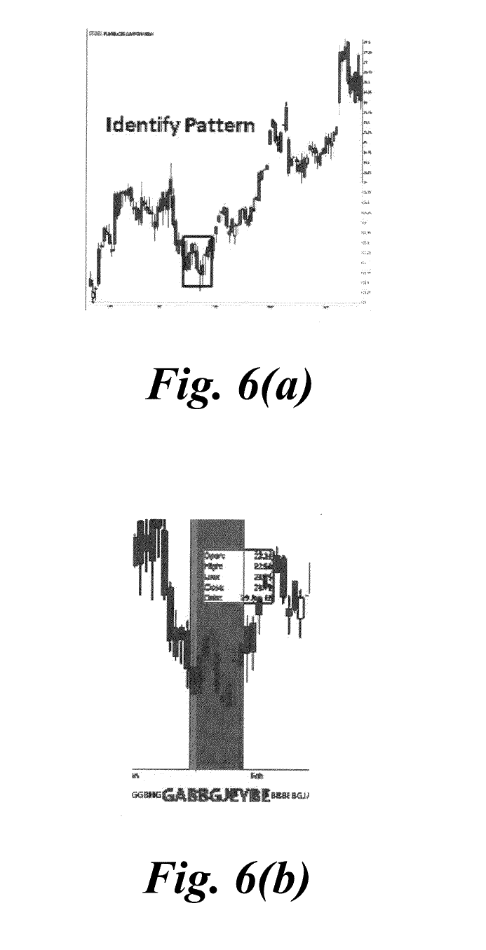

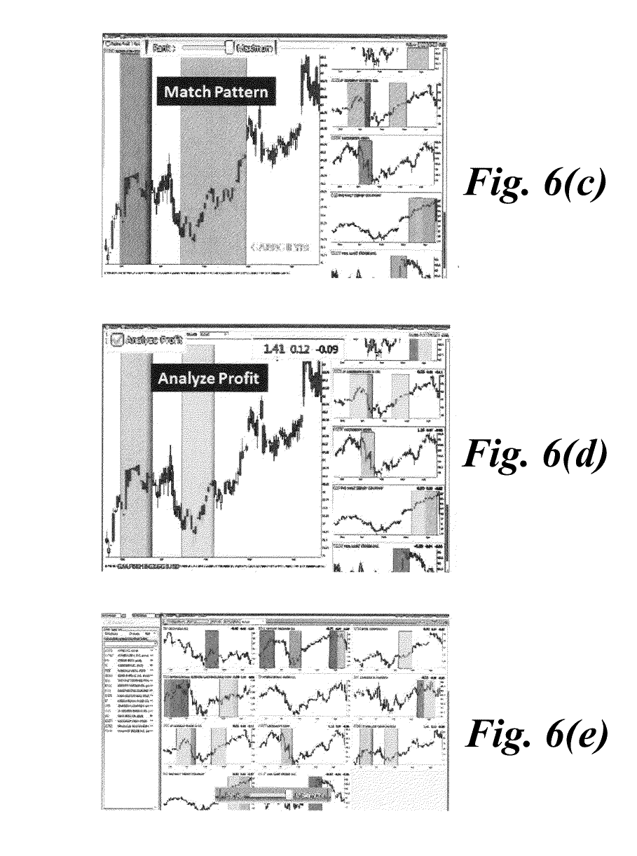

Referring to FIG. 6, there is shown a number of screenshots illustrating the steps of the method according to the present invention. In FIG. 6(a) a pattern is identified by a user. This pattern is highlighted by the user in FIG. 6(b) and has the character sequence “GABBGJEYBE”. In FIG. 6(c), the pattern is matched across the market data and in FIG. 6(d) all matched patterns are assessed for suitability before the patterns are provided to the end-user in FIG. 6(e). In FIG. 6(e), it can be seen that the user has the functionality to adjust the sensitivity of the searches carried out. In doing so, if the user wishes to ensure that only exact matches are obtained, they can impose strict criteria on the minimum level of pattern accuracy required, in order to remove unwanted, imperfect results from the searches. Similarly, it is envisaged that they can broaden out the search and accept non-identical matching patterns by altering the similarity matrix and the gap penalty appropriately.

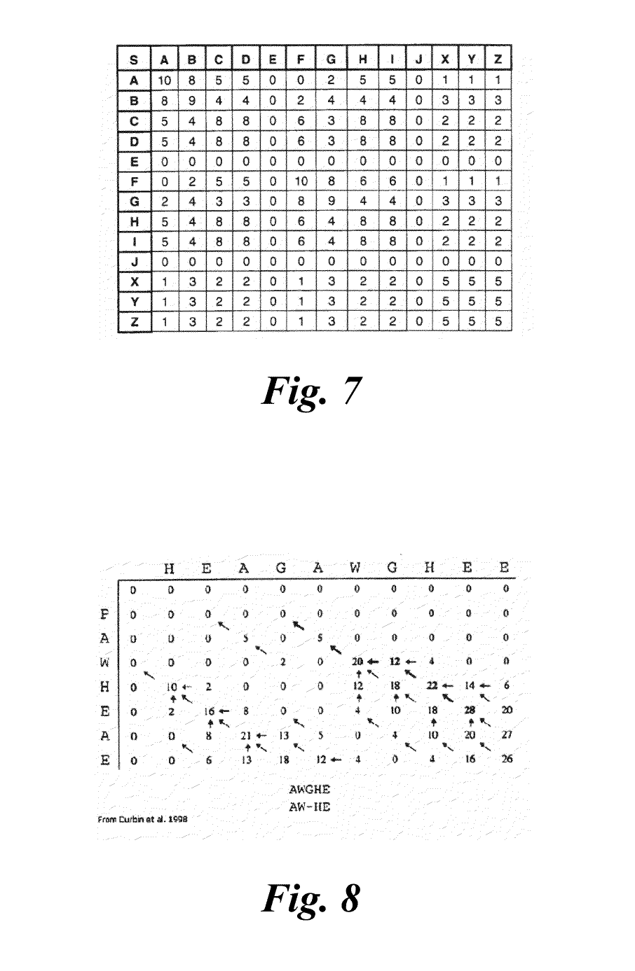

Referring now to FIGS. 7 and 8, a more comprehensive description of the pattern matching is provided. The Pattern Matcher is based on the premise that candlestick representations of financial data sequences can be converted to a sequence of letters. Each letter corresponds to a candlestick ‘shape’, of which there is a relatively small alphabet. These letter sequences can then be more effectively searched than the original data.

The algorithm according to the present invention uses elements of both the Needleman-Wunsch and the Smith-Waterman algorithm, with a few important enhancements. A custom similarity matrix is used to define the varying degrees of similarity between each general candlestick shape. Additionally, since the data is essentially a time-series, unlike DNA sequences, it is useful to find not just the best match, but every match within the series where a particular pattern (or any pattern that is sufficiently similar) reoccurs. According to the present invention, the method also identifies overlapping sequences, marking down those that overlap with higher-ranked matches.

The conventional Smith-Waterman algorithm was designed to find the single best local alignment of a relatively small pattern, within a larger generally dissimilar sequence. The Needleman-Wunsch algorithm finds the single best global alignment, and therefore does not support sequence gaps (i.e. insertions and deletions). It is more suitable for sequences that are generally similar and of roughly the same size.

Local-alignment is necessary, but only if it is both optimal, and returns a ranked list of optimal matches. Global-alignment is not suitable as it is not effective on ‘gappy’ dissimilar sequences. While Smith-Waterman is optimal and works well on the converted financial data, it does not produce a ranked list of results, but it is a suitable start-point for further enhancements.

However, a major problem with both the conventional Smith-Waterman and Needleman-Wunsch algorithms is that finding only the single best alignment is insufficient for the purposes of time-series financial market data. The enhancements according to the present invention involve returning a ranked list of alignments. The end-user of the algorithm can then vary the sensitivity of the process to filter the list to the top matches throughout the time-series. Additionally the present invention defines its own custom similarity matrix to account for the relative nature of the similarities and corresponding differences between candlestick types (the “DNA Bases”).

According to the invention, the first step is to define the mapping between each financial candlestick data and one of the 13 characters, where ‘Zero’ represents a tolerance of +/−0.2% of the closing price value, around 0.0.

The second step, like in the Needleman-Wunsch algorithm, involves defining a custom similarity matrix S for use when generating a scoring matrix. The custom similarity matrix S is shown in FIG. 7.

The third step of the method comprises defining a scoring scheme function ω (see step 4)

ω(c,d), c,dεΣ□ as the similarity matrix value S[c,d]

ω(c,−)=ω(−,d),c,dεΣ=−1 (gap penalty)

The fourth step, as in the conventional Smith-Waterman algorithm, comprises generating a ‘scoring’ matrix as follows:

H(i,0)=0, 0≦i≦m

H(i,0)=0, 0≦j≦n

$$H ( i , j ) = max \{ \begin{matrix}0 & \\ H ( i - 1 , j - 1 ) + w ( {a}_{i} , {b}_{j} ) & Match / Mismatch \\ H ( i - 1 , j ) + w ( {a}_{i} , - ) & Deletion \\ H ( i , j - 1 ) + w ( - , {b}_{j} ) & Insertion\end{matrix} \} , \\ 1 \leq i \leq m , \\ 1 \leq j \leq n$$

where:
a=long ‘source string’ over alphabet Σ
b=short ‘search pattern’ over alphabet Σ
m=length(a)
n=length(b)

The fifth step comprises, instead of identifying only the single highest score in the matrix (as in both Needleman-Wunsch and Smith-Waterman), each score value in the matrix H is added to an ordered key/value collection. The key is the rank score; the value is a list of locations within that matrix (and hence ‘source string’ positions) where that rank occurs. This allows efficient processing of matches by allowing an efficient search back through the matrix in a rank-descending order.

It has been found that in financial data, patterns found within the longer ‘source string’ are often quite localised. This means that multiple overlapping high ranking matches are often found in close proximity. Since this is not ideal, it is necessary to prioritise those matches with higher ranks over lower ranking, overlapping matches by introducing a penalty for each overlapping letter (this is elaborated upon in step 7 below).

The difficulty comes with overlapping matches of the same rank—which alignments should be considered ‘better’, and which alignments should be subject to overlap penalties. The goal is to distribute the penalties unevenly such that some of the otherwise same-ranking matches are subject to as few overlap penalties as possible while a minority have their rank downgraded disproportionately.

The key/value collection described above associates the list of locations with a specific rank. In doing so it implicitly defines the order in which the patterns associated with each location are processed. So for each list of same-ranking locations, they are ordered by position within the ‘source string’, alternatively maximising then minimising the distance to the start of the string. This maximises the distance between each pair of entries in each list, minimising the overlap between entries closer to the start of each list. In doing so it concentrates the overlap penalties in entries towards the end of each list, since the distance between ‘source string’ positions of each successive pair reduces.

The sixth step is to iterate through each matrix location in the key/value collection of step 5, in the rank order highest to lowest, and location list (associated with each rank) first to last. Using each matrix location as a start point, the full alignment is generated by tracing back through the matrix, just like in the conventional Smith-Waterman or Needleman-Wunsch algorithms as illustrated in FIG. 8. Also, any partial alignments that overlap the start or end of the ‘source string’ are not considered useful, and so must be excluded at this point.

The seventh step comprises the following actions. Since high ranking results tend to be quite localised, and generally overlap each other heavily, the rank for each alignment produced in step 6 needs to be adjusted to account for these overlaps, as already proposed above. The order of processing of alignments has already been defined in the sixth step above, and ensures that for any particular alignment we are guaranteed to know in advance the exact positions in the source string of all higher ranking, and same-ranking but higher priority alignments.

Then for each alignment whose rank meets some minimum user-defined criteria relative to the highest ranking score, the method comprises:
(i) Getting a full list of the scores of each individual step as it traced back through the matrix (step 6), in descending order.
(ii) Computing an ‘adjusted’ rank score by applying an overlap penalty of −1 every time the current alignment's path overlaps a higher-ranking or higher-priority alignment. A table of highest ranks per source string position are tracked via a ‘rank array’ with length matching the source string.
(iii) The final ‘adjusted’ rank score is then written to this rank array for each location in the current alignment where the score sets a new high for the corresponding position in the source string.
(iv) Once the final adjusted score meets some minimum user-defined criteria relative to the highest ranking score, the alignment, along with its adjusted score and corresponding dates, are added to the list of results to be returned to the user.

At any point in step 6, while tracing back through the matrix, there can always be more than one possible direction to take—when more than one of the options ‘up’, ‘left’ and ‘diagonal’ from the current matrix element have the same score. In this case, the algorithm recursively follows all maximum-score paths through the matrix. It does not assume that there will only ever be a single path for any particular start point. Once there are no more alignments to be processed, the results are ordered by descending rank and returned to the user.

In the example described above, a search for a cup and handle pattern was used to demonstrate the application of the present invention. This was due to the fact that the cup and handle pattern is a relatively simple pattern to demonstrate and identify. However, the cup & handle pattern is in fact an example of a “macro-pattern”. In other words, the cup and handle pattern will normally be formed over a very long time period, as described above. The DNA pattern matching methodology according to the present invention is in fact particularly suitable for and effective at detecting “micro-patterns” which are relatively short-term patterns. Generally speaking, the method according to the invention is more suitable for detecting micro-patterns than macro-patterns and the full advantages and benefits of the invention will really only become readily apparent when searching for micro-patterns. It is unlikely that the present invention would be used effectively to find the cup and handle pattern specifically however once again the cup and handle pattern was used in the example only to demonstrate the operation of the invention on an identifiable pattern.

Throughout the specification reference has been made to a method of identifying patterns in stock market data. It will be understood that the present invention is equally applicable to foreign exchange market data and other market data including, for example bonds, commodities and other financial instruments. Therefore, the present invention does not relate solely to identifying patterns in an individual company's stock price or an index stock price, but can be applied to a wide range of other financial instruments and essentially may be used with any large-scale time-series based data sets that have distinct timer periods.

Furthermore, various DNA search algorithms have been described in the specification, however, it is envisaged that other DNA search algorithms may also be used to good effect. In addition to the above techniques, it is envisaged that other sequence alignment algorithms that might be applicable include BLAST and its derivatives, FASTA, Profile HMMs probabilistic models (for example in HMMER/HMMRE3). There are several variations of the above techniques and techniques that would also be suitable that be immediately apparent to the skilled addressee once the general premise of the invention has been disclosed to them and the present invention in intended to cover these working variations and techniques also.

It will be understood that the invention is carried out by a processing module which may reside in software, hardware of a combination of both. In particular, the processing module may largely reside in software and specifically software running on a computer. Therefore, the present invention also relates to a computer program having program instructions for causing a computer to implement the method according to the invention. The computer program may be stored on or in a carrier such as a floppy disk, a CD ROM, a DVD, a ROM, a RAM, a DRAM, an EPROM, a PROM, a memory stick, or other storage device capable of storing a computer program in electronic format. The carrier may also comprise a transmissible carrier such as a carrier wave upon which the program is carried, said carrier wave may be transmitted via mobile telephony networks, wireless networks, wired networks, through fibre-optic cable and the like, in which case the cable may be considered to be a carrier. The program code may be in source code, object code, or format intermediate source and object code.

Finally, it is envisaged that in certain cases, the processing module may be implemented in a number of sub-modules. The sub-modules may be located on a single device or on a plurality of devices, which devices may be remote from each other. For example, the step of converting the stock market data for a given time period into a character representation of the stock market data may be carried out by a processing sub-module on a first computing device and the step of generating a string of character representations of the stock market data for a plurality of given time periods may be carried out by that processing sub-module, separate processing sub-module on that device or on a second device. The step of searching a string of character representations for a given sequence of character representations may be carried out by a further processing sub-module on a third device, or on either of the first or second devices mentioned above. In this way, the processing can be spread across a number of different devices if desired. The claims of the present invention should be interpreted in such a manner to incorporate such a configuration.

Throughout this specification, reference is made to generating a character representation from the candlestick chart. However, it will be understood that it is not absolutely necessary to generate the candlestick chart in order to create a character representation. In reality the candlestick is a visual representation of the stock market data, and it is the semantics of that visual representation that is being converted into the character representation. The actual conversion process does not involve the candlestick representation itself. The candlesticks are useful for the generation of the similarity matrix as it is possible for an individual to examine the visual representation of a candlestick and from that determine how similar or not it is to a different candlestick. Once the similarity matrix is complete, the method may operate purely from the open, high, low and close (OHLC) values for the time period. Therefore, strictly speaking, the conversion of the market data into candlesticks is not a necessary step for the method according to the present invention to work, but certain elements of the method, for example, the Similarity Matrix, are initialized based on an understanding of the visual representation of the market data in the form of a candlestick.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is in no way limited to the embodiment hereinbefore described but may be varied in both construction and detail within the scope of the appended claims.

1. A method of identifying patterns in stock market data, the method operating in a system comprising a processing module, the method comprising the steps of:
(a) the processing module converting the stock market data for a given time period into a character representation of the stock market data;
(b) the processing module generating a string of character representations of the stock market data for a plurality of given time periods; and
(c) the processing module searching the string of character representations for a given sequence of character representations, the sequence representing a known pattern.

2. A method as claimed in claim 1 in which the step of the processing module converting the stock market data for a given time period into a character representation of the stock market data comprises the steps of:
(d) the processing module converting the stock market data into a candlestick bar; and thereafter
(e) the processing module converting the candlestick bar into a character representation according to a set of conversion rules.

3. A method as claimed in claim 1 in which the step of the processing module searching the string of character representations for a given sequence of character representations comprises the processing module applying a DNA search string algorithm to the sequence of character representations and the string of character representations.

4. A method as claimed in claim 3 in which the DNA search string algorithms are modified DNA search string algorithms adapted to retrieve close approximations of the optimum matching pattern and return a ranked list of matches.

5. A method as claimed in claim 3 in which the modified DNA search string algorithm is a hybrid DNA search string algorithm comprising elements of two or more DNA search string algorithms.

6. A method as claimed in claim 1 in which the step of the processing module searching the string of character representations for a given sequence of character representations comprises applying a Needleman-Wunsch algorithm to the sequence of character representations and the string of character representations.

7. A method as claimed in claim 1 in which the step of the processing module searching the string of character representations for a given sequence of character representations comprises applying a Smith-Waterman Algorithm to the sequence of character representations and the string of character representations.

8. A method as claimed in claim 1 in which the step of the processing module searching the string of character representations for a given sequence of character representations comprises applying Sellers Algorithm to the sequence of character representations and the string of character representations.

9. A method as claimed in claim 1 in which the character representation is an alphabetical character.

10. A method as claimed in claim 1 in which the stock market data for a particular time period is converted into one of thirteen characters.

11. A method as claimed in claim 1 in which the step of the processing module searching the string of character representations for a given sequence of character representations comprises the initial step of:
(f) defining a custom similarity matrix to define the varying degrees of similarity between the characteristics of stock market data as represented by candlesticks of specific time periods.

12. A method as claimed in claim 1 in which the custom similarity matrix defines the varying degrees of similarity between candlestick bar shapes.

13. A method as claimed in claim 1 in which the method comprises the further step of:
(g) the processing module returning a ranked list of identified patterns.

14. A method as claimed in claim 1 comprising the step of the user selecting a desired sensitivity to the search thereby filtering out unsuitable matches.

15. A method as claimed in claim 1 comprising the processing module generating a scoring matrix and adding each score value in the scoring matrix to an ordered key/value collection.

16. A method as claimed in claim 15 in which the key is the ranking and the value is a list of locations within the scoring matrix where that ranking occurs.

17. A method as claimed in claim 1 comprising the step of the processing module converting a combination of two or more character representations into a second character representation.

18. A computer program having program instructions that when executed on a computer causes the computer to implement the method of claim 1.

19. A method as claimed in claim 1 combined with known existing investment strategies to form an amalgamated rule; and, real-time monitoring of stock market data is conducted to detect concurrence with the amalgamated rule.
